(19) United States
(12) Patent Application Publication
(10) Pub. No.: US 2006/0204922 A1
(43) Pub. Date: Sep. 14, 2006

(54) Portable dental system, and related methods, for performing endodontic and surgical procedures in the field

(76) Inventors: George P. Anderson, Mill Creek, WA (US); Daniel Thacker, Snohomish, WA (US); Jan Wietecha, Bothell, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/078,220

(22) Filed: Mar. 11, 2005

(51) Int. Cl. A61C 13/38; A61C 17/02

(52) U.S. Cl. 433/77; 433/80

(57) ABSTRACT

A portable dental system comprises a drill system for drilling, a fluid delivery system irrigating the drill system and the patient's mouth, a battery for powering the drill system and the fluid delivery system, control circuitry for controlling the drill system and the fluid delivery system, and a housing. The housing protects the drill system, the fluid delivery system, the battery and the control circuitry, and defines a cavity sized to retain them. With the battery internal to the portable dental system, the system can be used in any environment that does not include an external power source. The control circuitry includes a power circuit for powering the drill system and the fluid delivery system from power provided by an external source, such as a 24-volt DC vehicle battery, a 12-volt DC vehicle battery, or a generator that can generate 110 volts AC or 220 volts AC. The portable dental system weighs less than 35 lbs and may be easily carried.

### BACKGROUND

Portable dental systems allow one to perform endodontic and/or surgical procedures on patients in the field, that is, outside of a dentist's or other medical professional's office. For example, a military medical technician can address a soldier's dental problems where the soldier is located, such as at an outpost. Or, a dentist can address an elderly patient's dental problems in the patient's own home so that the patient does not have to travel to the dentist's office.

The endodontic and surgical procedures that are most frequently performed in the field include removing cavities and removing decaying pulp from a tooth. To perform these procedures a typical portable dental system includes a drill having a motor and a removable file for drilling, reaming and abrading a tooth and other tissue. A typical portable dental system also includes an air/water delivery system for drying and lubricating the file and rinsing a patient's tooth, and a power source to power the drill and air/water delivery system.

Unfortunately, many portable dental systems that include these components are heavy and cumbersome to carry, and frequently rely on power from an external power source. Many portable dental systems weigh over 35 lbs. and require power from a wall outlet, gas-powered generator, or battery from another system such as a vehicle. Such dental systems typically do not include an internal battery—a battery included in the system and dedicated to powering the drill and air/water delivery system when desired. By requiring an external power source, the environments where these portable dental systems can be used is limited to those where an external power source exists. Furthermore, most portable dental systems that receive power from an external source typically require a narrow range of voltages, for example around 12 volts. Thus, one typically cannot use a battery that generates more volts, for example 24 like the typical military vehicle battery generates, to power the portable dental system.

Thus, there is a need for a portable dental system that weighs less than 35 lbs. so that the system can be easily carried by one person, and that can be powered by many different power sources that provide a wide range of voltages so that the system can be used anywhere.

### SUMMARY

In one aspect of the invention, a portable dental system comprises a drill system for drilling, reaming and/or abrading a tooth and other tissue, a fluid delivery system that is operable to irrigate the drill system and tissue, a battery operable to power the drill system and the fluid delivery system, control circuitry operable to control the drill system and the fluid delivery system, and a housing. The drill system includes a rotary file operable to remove tissue from a patient, a motor operable to rotate the rotary file, and a hand-piece operable to couple the rotary file with the motor, and to provide a grip for holding the drill system while the motor rotates the rotary file. The fluid delivery system includes a fluid reservoir to store fluid, a nozzle operable to dispense fluid from the fluid reservoir, and a pump operable to pressurize the fluid reservoir. The housing protects the drill system, the fluid delivery system, the battery and the control circuitry, and defines a cavity sized to retain them. With the battery internal to the portable dental system, the system can be used in any environment that does not include an external power source.

In another aspect of the invention, the portable dental system weighs about 35 lbs. Thus, one can easily carry the system.

In yet another aspect of the invention, the control circuitry includes a power circuit operable to power the motor of the drill system and the pump of the fluid delivery system from power provided by an external power source. The external power source may be a battery that can generate 24 volts DC, 12 volts DC or any desired voltage, or a generator that can generate 110 volts AC or 220 volts AC.

### BRIEF DESCRIPTION OF THE FIGURES

FIG. 1 is a perspective view of a portable dental system, according to an embodiment of the invention.

FIG. 2 is a perspective view of the portable dental system in FIG. 1 with all of its components disposed in a housing.

FIG. 3 is an exploded perspective view of the portable dental system in FIG. 1.

FIG. 4 is a schematic view of a fluid delivery system incorporated by the portable dental system in FIG. 1.

FIG. 5 is a schematic diagram of a control unit incorporated by the portable system in FIG. 1.

FIG. 6A is a perspective view of a hand piece included in the drill system that is incorporated by the portable dental system in FIG. 1.

FIG. 6B is a view of a portion of the hand piece in FIG. 6A.

FIG. 7 is a view of an interface that is incorporated by the control unit in FIG. 5.

### DETAILED DESCRIPTION

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

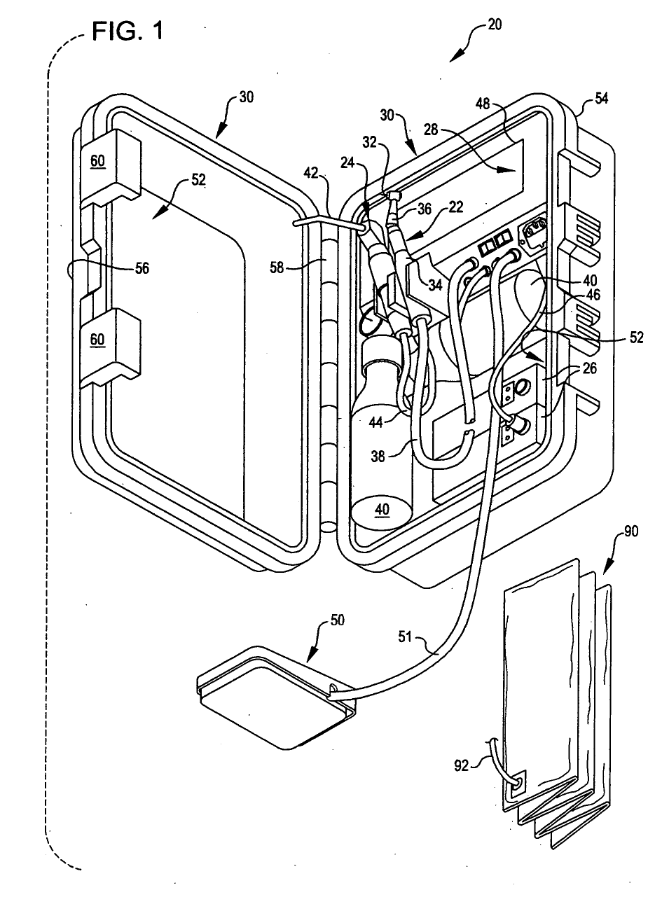

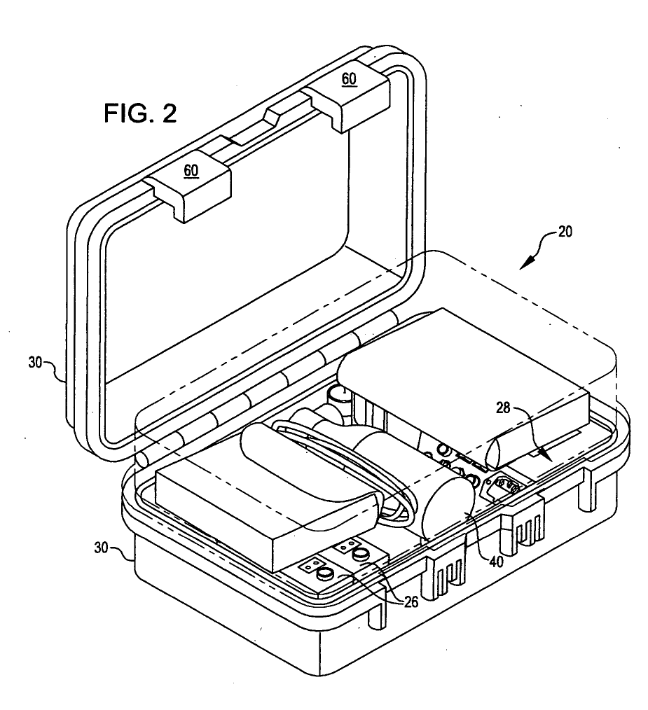

FIGS. 1 and 2 are perspective views of a portable dental system 20 according to an embodiment of the invention. FIG. 1 shows the system 20 open and accessible by a medical professional (not shown) such as a dentist or a medical technician to perform an endodontic and/or surgical procedure on a patient (not shown). FIG. 2 shows the system 20 with all of its components packed away and ready to be closed for carrying.

The portable dental system 20 includes a drill system 22 to remove tissue (not shown) from a patient's tooth (not shown), such as the pulp (not shown) from a tooth's root canal (not shown), a fluid delivery system 24 to irrigate the tissue of the patient and drill system 22, a battery 26 to power the components, which includes the systems 22 and 24, of the system 20, a control unit 28 to control the components of the system 20, and a housing 30 to protect the components of the system 20. In one embodiment, the system 20 includes two batteries 26 that can each power the system 20. Thus, when one of the batteries 26 powers the system 20, the other battery 26 provides an alternate source of power that can be used to power the system 20 should the initial battery 26 fail. Furthermore, the system 20 weighs less than 35 lbs., for example 25 lbs., to facilitate one person carrying it.

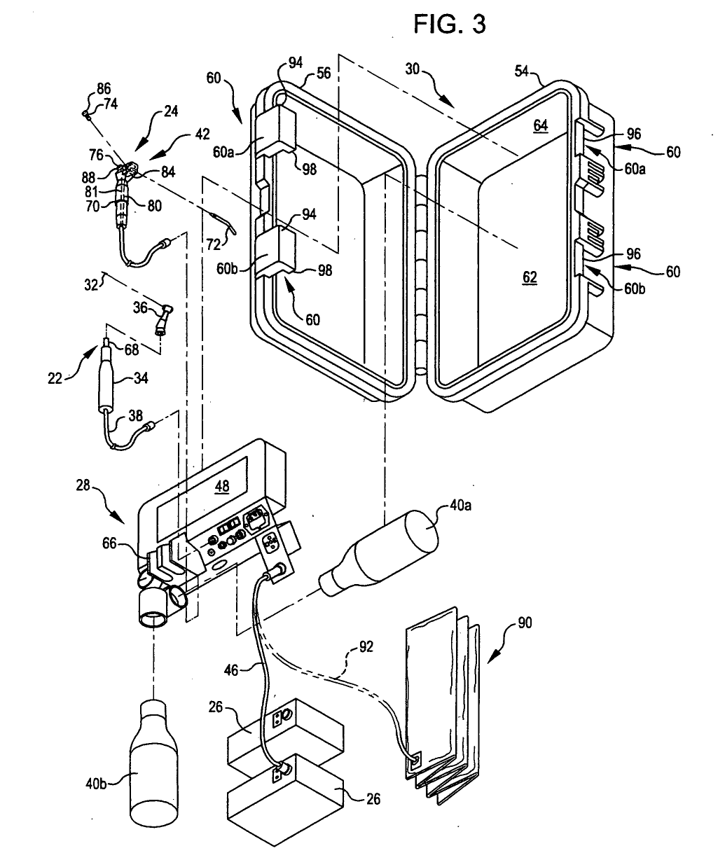

The drill system 22 (discussed in greater detail in conjunction with FIGS. 3, 6A and 6B) includes a rotary file 32 to remove tissue from a patient, a motor 34 to rotate the file 32, and a hand-piece 36 to couple the file 32 with the motor 34 and to provide a grip for holding the drill system 22 during a procedure. The drill system 22 also includes a cable 38 to couple the motor 34 with the control unit 28. In one embodiment, the cable 38 includes a conduit (not shown) to contain water flowing toward the motor 34 and a conductor (not shown) to transmit electricity toward the motor 34 for power. In other embodiments, a first cable may include the conduit for water, and a second, separate cable may include the conductor for electrical power.

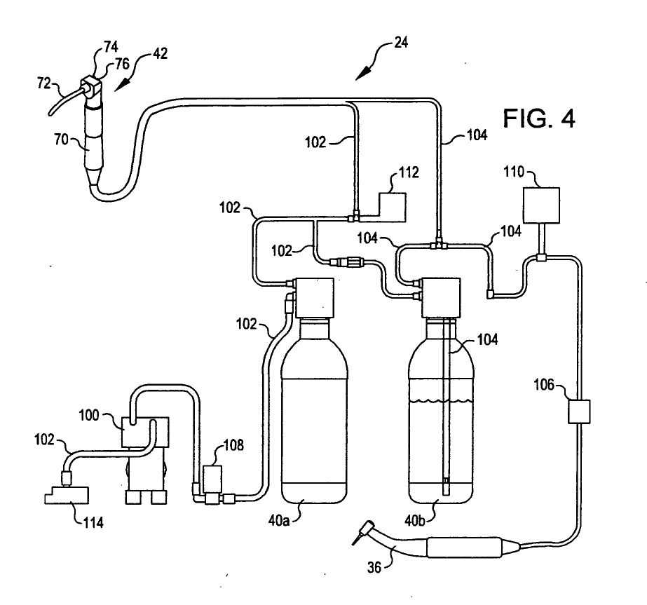

The fluid delivery system 24 (discussed in greater detail in conjunction with FIGS. 3 and 4) includes a fluid reservoir 40 to store fluid, a nozzle 42 to dispense the fluid, a pump (not shown in FIGS. 1 and 2) to propel fluid through the system 24, and a conduit 44 to couple the nozzle 42 to the fluid reservoir 40 and contain fluid flowing toward the nozzle 42. The system 24 delivers any desired fluid to the patient and drill system 22 to irrigate them. For example, in one embodiment the system 24 delivers air through a first conduit (not shown) to the nozzle 42 that one can use to blow off unwanted debris from the tooth, file 32 or other part of the drill system 22. The system 24 also delivers water through a second conduit (not shown) to the nozzle 42 that one can use to irrigate the patient's tissue or other components of the portable dental system 20. The fluid delivery system 24 also delivers water to the drill system 22 through the cable 38 to lubricate and cool the file 32 as it drills, reams or abrades tissue.

The battery 26 powers the motor 34 of the drill system 22, the pump of the fluid delivery system 24 and the control unit 28, when an external power source is not used to power the components of the system 20. The cable 46 couples the battery 26 with the control unit 28 so that the battery 26 can power the control unit 28 and other components of the system 20.

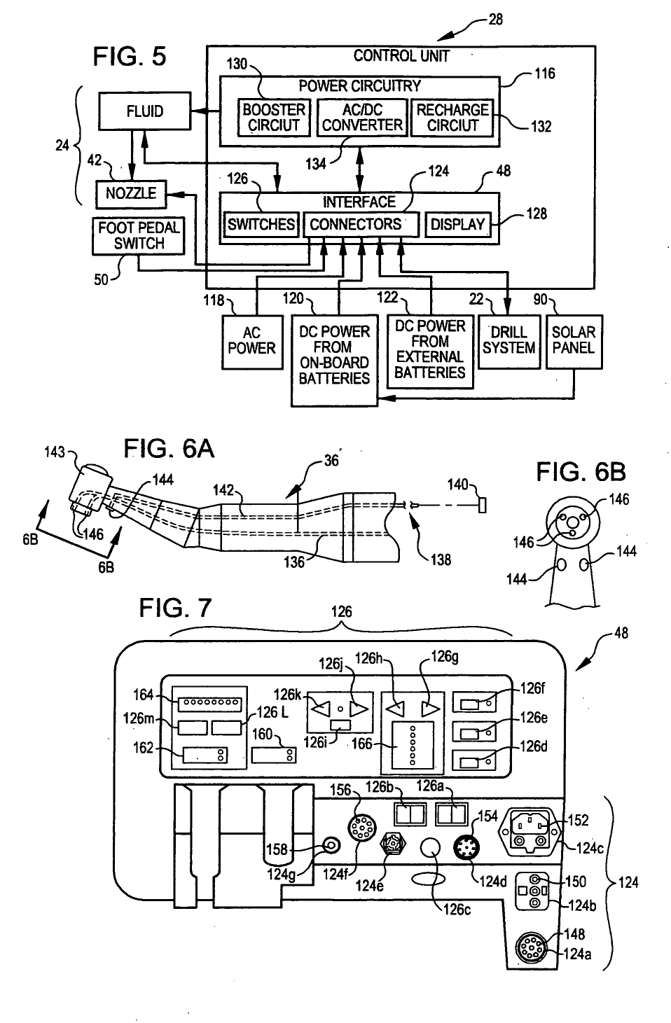

The control unit 28 (discussed in greater detail in conjunction with FIGS. 3 and 5) includes power circuitry (not shown in FIGS. 1 and 2 but shown in FIG. 5 and discussed in greater detail in conjunction with FIG. 5) to provide power to the components of the system 20 from the power provided by the battery 26 or an external power source such as a vehicle battery or a gas powered generator. The control unit 28 also includes an interface 48 (discussed in greater detail in conjunction with FIGS. 5 and 7) to allow one to input data to the control unit, and the control unit 28 to display data. The interface 48 may or may not include a foot switch 50 and cable 51 to allow one to control the drill system 22 with one's foot. The foot switch 50 may be advantageous if the procedure to be performed requires one's hands for other activities.

The housing 30 defines a cavity 52 sized to retain the drill system 22, the fluid delivery system 24, the battery 26 and the control unit 28, and that protects the systems 22 and 24, the battery 26 and the control unit 28 when each is disposed in the cavity 52. For example, in one embodiment, the housing 30 includes a first section 54 that the systems 22 and 24, the battery 26 and the control unit 28 are mounted to, and a second section 56 that includes a hinge 58 to connect the second section 56 to the first section 54 and allow the sections 54 and 56 to pivot relative to each other to open and close the portable dental system 20. In addition, the housing 30 includes a lock 60 to prevent the second and first sections 54 and 56 from pivoting relative to each other when the housing 30 is closed. Thus, one can secure the system 20 closed while carrying the system to protect the system's components during travel. Furthermore, the housing 30 may be made from any desirable material that is durable and light. For example, in one embodiment the housing is made from conventional polyethylene plastic. In other embodiments the housing may be made from other desirable plastics and/or metals such as aluminum.

FIG. 3 is an exploded, perspective view of the system 20 in FIGS. 1 and 2.

The control unit 28, drill system 22, fluid delivery system 24 and batteries 26 may be mounted to the housing 30 in any manner desired. For example, in one embodiment, the control unit 28, systems 22 and 24 and batteries 26 are mounted to the first section 54 using conventional fasteners such as screws. The first section 54 includes a back wall 62 to which the batteries 26 and the control unit 28 are mounted, and a sidewall 64 to which the control unit 28 is also mounted. The tool holder 66 is mounted to the control unit 28 using conventional fasteners and can hold the nozzle 42 and the hand-piece 36 of the drill system 22 when these are not being used.

Still referring to FIG. 3, the drill system 22 includes two or more files 32 (only one shown) that can be removably attached to the hand-piece 36 to drill, ream or abrade, a hand-piece 36 that can change the rotational speed of the file 32 relative to the output shaft 68 of the motor 34, and any desired motor capable of rotating the output shaft 68 at a desired speed and generating a desired torque. For example, in one embodiment, the system 22 includes a conventional mechanism (not shown) for removably attaching the file 32 to the hand-piece 36, and a set of files (not shown), which includes the file 32, for drilling into a tooth's root canal. The files in the set typically differ in size and configuration to accommodate a variety of different tooth canal geometries. The set of files can also include a file (not shown) for abrading a tooth's enamel. The hand-piece 36 increases the rotational speed of the file 32 by a factor of five relative to the rotational speed of the output shaft 68, i.e. the ratio of the speeds is 5:1. This may be desirable when a procedure requires the file 32 to rotate fast without an increase in torque. The hand-piece 36 is also angled to facilitate comfortably holding the hand-piece 36 while performing a procedure. The motor 34 is a brushless DC motor capable of rotating the output shaft 68 at 30,000 rpm, and is removably attached to the hand-piece 36 using a conventional mechanism (not shown). The rotational speed of the output shaft 68 that is generated by the motor 34 increases as the voltage to the motor 34 increases. For example, the rotational speed of the output shaft 68 increases about 1,000 rpms for each 1-volt increase in the power supplied to the motor 34.

Other embodiments are contemplated. For example, the hand-piece may be straight and neither increase nor decrease the rotational speed of the file 32 relative to the motor's output shaft 68. In still other embodiments, the hand-piece 36 may decrease the rotational speed of the file 32 relative to the motor's output shaft 68. This may be desirable when a procedure requires an increase in torque supplied to the file 32 without an increase in rotational speed. Also, the motor 34 may be an AC motor. This would require a DC to AC converter incorporated in the power circuitry of the control unit 28 to convert the DC power generated by the batteries 26 into AC power for the motor 34, and, when the system 20 is powered with AC power, a by-pass circuit to avoid the DC to AC converter included in the power circuitry.

Still referring to FIG. 3, the fluid delivery system 24 includes a nozzle 42 that allows one to discharge more than one fluid individually or combined. For example, in one embodiment, the system 24 includes an air bottle 40a and a water bottle 40b (discussed in greater detail in conjunction with FIG. 4), and the nozzle 42 includes a body 70, a needle 72 to discharge fluid, a first valve 74 to control the flow of air through the nozzle 42, and a second valve 76 to control the flow of water through the nozzle 42. The body 70 includes a line 80 to contain air as it flows toward the needle 72, a line 82 to contain water as it flows toward the needle 72, and a chamber 84 that receives the air, water or both before they are discharged from the needle 72. Each valve 74 and 76 are located in the body 70 to control the flow of air and water before the air and water enter the chamber 84. To open each valve 74 and 76, and allow air and water to enter the chamber 84 and subsequently be discharged from the needle 72, one pushes the end 86 or 88 toward the body. By pushing both ends 86 and 88 at the same time, the nozzle 42 discharges a combination of air and water to form a mist. The needle 72 is removably attached to the body 70 using any desired conventional technique.

Still referring to FIG. 3, the batteries 26 may be any desired type of battery. For example, in one embodiment, each battery is a nickel-cadmium, rechargeable battery that can generate 27.6 volts. As discussed in greater detail in conjunction with FIG. 5, the power circuitry (116 in FIG. 5) includes a recharge circuit (not shown) that can recharge the batteries 26 when the system 20 is powered by conventional AC power available in most homes, or DC power from one or more external power sources, such as a vehicle battery. In addition, the system 20 includes a solar panel 90 (also shown in FIG. 1) for generating electricity from light, and a cable 92 (also shown in FIG. 1) to transmit the electricity to the power circuitry to recharge the batteries 26. Thus, one can recharge the batteries 26 using sunlight and use the system 20 for extended period(s) of time in the absence of an external power source.

Still referring to FIG. 3, the housing 30 includes a lock 60 that can be any desired lock capable of releasably securing the second section 56 of the housing 30 to the first section 54. For example, in one embodiment, the housing includes two locks 60a and 60b, and each lock 60a and 60b includes a latch 94 mounted on the second section 56 and a receiver 96 mounted on the first section 54 that receives and retains the latch 94 to lock the system 20 closed. When the system 20 is locked closed, one unlocks the system 20 by moving the tab 98 away from the first section 54. Then, when the system 20 is open, one locks the system 20 by first pivoting the second section 56 to the first section 54 and then moving the tab 98 toward the first section 54 to insert the latch 94 into the receiver 96.

FIG. 4 is a schematic view of the fluid delivery system 24 of the portable dental system 20 (FIGS. 1-3). The fluid delivery system 24 may be any desired fluid delivery system capable of discharging any desired fluid. For example, in one embodiment, the fluid delivery system 24 includes a pump 100 to generate air pressure, an air bottle 40a to hold air pressurized by the pump 100 and provide the system 24 air whose pressure is substantially consistent over a period of time, a water bottle 40b to hold water, a line 102 for containing air as the air is distributed in the system 24, and another line 104 for containing water as the water is distributed in the system 24. The system 24 also includes a valve 74 for allowing and preventing air to flow out of the nozzle 42, and a valve 76 for allowing and preventing water to flow out of the nozzle 42. In addition, the system 24 includes a valve 106 for controlling the flow rate of water toward the hand-piece 36 of the drill system 22 (FIGS. 1 and 3), and another valve 110 to allow and prevent water to flow toward the hand-piece 36. In addition, the system 24 includes a valve 108 to relieve air pressure in the line 102 when the pump 100 starts to keep the pump 100 from stalling, and a pressure switch 112 to turn off the pump 100 if the air pressure in the line 102 exceeds a desired pressure. Furthermore, the system 24 includes a filter 114 to clean the air pulled into the system 24 by the pump 100. Moreover, the pump 100, switch 112, filter 114 and valves 106, 108 and 110 are each conventional and selected to provide a desired performance.

In operation, the pump 100 draws air from the surrounding environment through the filter 114 and into the system 24 and pressurizes it. The pressurized air flows toward the air bottle 40a and is deposited in the air bottle 40a and in the water bottle 40b. The air deposited in the water bottle 40b pressurizes the bottle 40b and urges water into the line 104. When air or water is discharged from the nozzle 42, or water discharged through the hand-piece 36, the air pressure in the air bottle 40a drops. But because the volume of the air bottle 40a, and thus the mass of air stored in the bottle 40a, is significantly larger than the flow rate of the air or water through the nozzle 42, or the flow rate of the water through the hand-piece 36, the instantaneous drop in air pressure throughout the system 24 is low. Thus, one can discharge air through the nozzle 42 for a period of time, or simultaneously discharge water through the hand-piece 36 without quickly experiencing a significant loss in air and water pressure.

To discharge air from the nozzle 42, one moves the valve 74 as previously discussed to allow the pressurized air in the line 102 to escape through the nozzle 42. To discharge water from the nozzle 42 one moves the valve 76 as previously discussed to allow the water in the line 104 to escape through the nozzle 42. To discharge water through the hand-piece 36, one opens the valve 106 to allow the water in line 104 to escape through the hand-piece 36.

FIG. 5 is a schematic diagram of a control unit 28 incorporated in the portable dental system 20 (FIGS. 1-3). The control unit 28 includes power circuitry 116 to provide power to the components of the system 20, and an interface 48 to connect components of the system 20 and external power sources 118, 120, 122 to the power circuitry 116, to input data into the control unit 28 and to display data from the control unit 28. The interface 48 includes connectors 124 (discussed in greater detail in conjunction with FIG. 7) to couple the power circuitry 116 to components of the system 20, and to couple the nozzle 42 and other components to the fluid delivery system 24. The interface 48 also includes a set of switches 126 (discussed in greater detail in conjunction with FIG. 7) to input data into the control unit 24, and a display 128 (also discussed in greater detail in conjunction with FIG. 7) to display data from the control unit 28.

The power circuitry 116 includes a booster circuit 130 to increase the voltage to one ore more components of the system 20 relative to the voltage provided by the batteries 26 (FIGS. 1 and 3), or any of the external DC power sources 120 and 122. For example, in one embodiment, the booster circuit 130 includes a conventional voltage pump (not shown) having an inductor (not shown) to generate a current of electricity, a capacitor (not shown) to store the electrical charge provided by the current, and a diode (not shown) to prevent the charge in the capacitor from escaping back to the inductor. The pump is configured with the inductor, diode and capacitor connected in series, and a switch located between the inductor and the diode to connect the inductor to ground. The voltage across the capacitor is the boosted voltage that is supplied to the other components of the system 20. The voltage from the power source is boosted by the temporary current generated by the inductor when the inductor's magnetic field collapses after the switch breaks the inductor's connection to ground. To reestablish another magnetic field in the inductor, the switch re-connects the inductor to ground and electricity from the power source flows through the inductor.

When a component of the system 20 requires more voltage than the power source provides, the booster circuit 130 increases the voltage of the power supplied to the components. For example, if the drill motor 34 requires 30 volts but the system 20 receives 24 volts from a DC power source 122, then the booster circuit increases the voltage from the power source to 30 volts and supplies the 30 volts to the drill motor 34. Or, if one wants to recharge one of the batteries 26 from power supplied by a 12 volt DC external battery then the booster circuit 130 increases the voltage from the 12 volt battery to 30 volts, for example, and supplies the 30 volts to the battery 26.

The power circuitry 116 also includes a recharge circuit 132 to recharge the batteries 26 from the external power sources (118, 120, 122 and 90). When activated, the recharge circuit 132 provides power to the batteries 26. The recharge circuit 132 can also provide the batteries 26 power for recharging when the system 20 is being used and the external power source (118, 120, 122 or 90) provides more power than the system 20 requires.

In operation, the power circuitry 116 receives power from one or more of the following power sources, a battery 26, the solar panel 90, an external AC power source 118, and an external DC power source 122. When the system 20 receives power from an AC power source, an AC to DC converter 134 of the power circuitry 116 converts the power into 27 volts DC and supplies this power to the components of the system 20. When the system 20 receives power from a battery 26 and the battery is fully charged, the battery 26 provides substantially 27.6 volts.

FIGS. 6A and 6B are views of the hand-piece 36 included in the drill system 20 in FIGS. 1-3. FIG. 6A is a side view of the hand piece 36, and FIG. 6B is a plan view of a portion of the hand piece 36.

The hand-piece 36 includes a fluid conduit 136 to hold fluid from the fluid delivery system 24 and direct it to the file 32 (FIGS. 1 and 3) and/or patient (not shown) to irrigate them, and may include other systems to facilitate performing a procedure. For example, in one embodiment, the fluid conduit 136 holds and directs water; and the hand-piece 36 includes a light system 138 to direct light onto the area of the patient that the file 32 (FIGS. 1 and 3) engages while one uses the drill system 22. The light system 138 includes a light-source 140 disposed on the motor 34 (FIGS. 1 and 3), which may include a conventional incandescent bulb or an LED, to generate light, and a fiber optic cable 142 to direct the light from the bulb 140 toward the head 143 of the hand-piece 36. At an exit 144 in the head 142, the light escapes the cable 142 and is directed toward the file 32 and patient. The fluid conduit 136 is sealingly coupled to the cable's conduit using any desired technique to prevent water from leaking from the coupling interface (not shown). The fluid conduit 136 includes three exit holes 146 located in the head 142 through which the water in the conduit escapes toward the file 32 and/or patient.

FIG. 7 is a view of the interface 48 incorporated by the control unit in FIGS. 1, 3 and 5. The set of connectors 124 of the interface 48 are used to couple the power circuitry 116 (FIG. 5) to components of the system 20, and to couple the nozzle 42 (FIGS. 1, 3 and 4) and other components to the fluid delivery system 24. The set of switches 126 of the interface 48 are used to input data into the control unit 28. And the display 128 is used to display data from the control unit 28.

Each connector in the set of connectors 124 may be any desired connector capable of removably fastening to the control unit 28 a cable from a component of the system 20 or an external power source. For example, in one embodiment, the set of connectors 124 includes seven connectors 124a-g. The connector 124a receives the cable 46 to connect one of the batteries 26 to the control unit 28. The connector 124a includes a receptacle 148 that is sized to frictionally engage a respective pin of a corresponding connector (shown in FIGS. 1 and 3 but without a reference number) of the cable 46, and thus hold the corresponding connector to the interface 48. The connector 124b receives a cable from a vehicle battery (not shown) to connect the vehicle battery to the control unit 28. The connector 124b includes a pin 150 that is sized to frictionally engage a respective receptacle of a corresponding connector (not shown), and thus hold the corresponding connector to the interface 48. The connector 124c receives a cable from a conventional AC power source 118 (FIG. 5) to connect the power source to the control unit 28. The connector 124c includes a pin 152 that is sized to frictionally engage a respective receptacle of a corresponding connector (not shown), and thus hold the corresponding connector to the interface 48. The connector 124d receives the cable 51 (FIG. 1) to connect the foot switch 50 to the control unit 28. The connector 124d includes a pin 154 that is sized to frictionally engage a respective receptacle of a corresponding connector (not shown), and thus hold the corresponding connector to the control unit 28. The connector 124e receives a fluid conduit 104 (FIG. 4) to connect the fluid conduit 136 of the hand-piece 36 to the fluid delivery system 24. The connector 124e includes a conventional mechanism to sealingly coupled to the conduit 104 and prevent water from leaking between the connector 124e and the conduit 104. The connector 124f receives the cable 38 (FIGS. 1 and 3) to connect the drill system 22 to the control unit 28. The connector 124f includes a pin 156 that is sized to frictionally engage a respective receptacle of a corresponding connector (shown in FIGS. 1 and 3 but without a reference number), and thus hold the corresponding connector to the control unit 28. The connector 124g receives a cable (not shown) to connect the light system 138 (FIGS. 6A and 6B) of the drill system 22 to the control unit 28. The connector 124g includes a pin 158 that is sized to frictionally engage a respective receptacle of a corresponding connector (not shown), and thus hold the corresponding connector to the control unit 28.

Still referring to FIG. 7, each switch in the set switches 126 may be any desired switch capable of providing the control unit 24 data when one operates the switch. For example, in one embodiment, the set of switches 126 includes thirteen switches 126a-m. The switch 126a is a toggle switch to allow or prevent AC power from the power source 118 (FIG. 5) to power the system 20 when the system is connected to the power source 118. If a DC power source from one of the batteries 26 (FIGS. 1-3) or an external source 122 (FIG. 5) is also connected to the system 20, positioning the switch 126a to power the system 20 from an AC power source prevents the DC power source from powering the system 20. The switch 126b is a toggle switch to allow or prevent DC power from one of the batteries 26 or the power source 122 from powering the system 20 when the system is connected to a battery 26 or the power source 122. The switch 126c is a knob that one rotates to adjust the amount of fluid the fluid delivery system 24 provides the hand-piece 36. Rotating the knob clockwise increases the amount of fluid to the hand-piece 36, and rotating the knob counterclockwise decreases the amount of fluid. The switch 126d is a push-button that one pushes to allow or prevent control of the drill system 22 by operating the foot switch 50. When the foot switch 50 is allowed to control the drill system 22, one can turn the motor 34 and the discharge of the fluid from the hand-piece 36 on or off. The switch 126e is a push-button that one pushes to reverse the rotation of the file 32. When the file 32 rotates clockwise and the switch 126e is pushed, the file 32 will rotate counterclockwise; if the file 32 rotates counterclockwise and the switch 126e is pushed, then the file 32 will rotate clockwise. The switch 126f is a push-button that one pushes to control the availability of fluid to the hand-piece 36 and nozzle 42 (FIGS. 1 and 3). When fluid is not available to the hand-piece 36 and nozzle 42 and the switch 126f is pushed, fluid will be available for discharge through the hand-piece 36 and nozzle 42. When fluid is available to the hand-piece 36 and nozzle 42 and the switch 126f is pushed, fluid will no longer be available. Switches 126g and 126h are push-buttons that one pushes to control the speed of the motor 34, and thus the rotational speed of the file 32. When the switch 126g is pushed the speed of the motor 34 increases, and when the switch 126h is pushed the speed of the motor 34 decreases. Switches 126i-k are push-buttons that one pushes to control the light system 138. When the switch 126i is pushed the light system 138 is turned on if previously off, and off if previously on. When the switch 126j is pushed the intensity of the light emanating from the exits 144 (FIGS. 6A and 6B) increases, and when the switch 126k is pushed the intensity of the light emanating from the exits 144 decreases. The switch 126L is a push-button that one pushes to turn on or off the pump 100 (FIG. 4). When the switch 126L is pushed the pump 100 is turned on if previously off, and off if previously on. The switch 126m is a push-button that one pushes to charge the batteries 26. When the system receives power from the solar panel 90 and/or an external source 118 (FIG. 5) or 122 (FIG. 5), and the switch 126m is pushed, the recharge circuit 132 (FIG. 5) diverts some or all of the power from the source to a battery 26.

Still referring to FIG. 7, the display 128 (FIG. 5) includes a battery fault display 160 that indicates when a problem exists with a battery 26 that is connected to the control unit 28, a power source indicator 162 to indicate the type of external power source currently powering the system 20, a battery power-level indicator 164 to show how much charge remains in a battery 26 that is connected to the control unit 28, and a motor speed indicator 166 to show how fast the output shaft 68 of the motor 34 rotates.

What is claimed is:

1. A portable dental system comprising:
a drill system that includes
a rotary file operable to remove tissue from a patient,
a motor operable to rotate the rotary file, and
a hand-piece operable to couple the rotary file with the motor, and to provide a grip for holding the drill system while the motor rotates the rotary file;
a fluid delivery system that is operable to irrigate the rotary file and tissue when the rotary file is used to remove tissue from a patient, and that includes
a fluid reservoir to store fluid,
a nozzle operable to dispense fluid from the fluid reservoir, and
a pump operable to pressurize the fluid reservoir,
a battery operable to power the motor of the drill system and the pump of the fluid delivery system;
a control unit operable to control the drill system and the fluid delivery system; and
a housing operable to protect the drill system, the fluid delivery system, the battery and the control unit.

2. The portable dental system of claim 1 wherein the system weighs less than 35 pounds.

3. The portable dental system of claim 1 wherein the system weighs approximately 35 pounds.

4. The portable dental system of claim 1 wherein:
the motor includes an output shaft that rotates, and
the hand-piece includes a transmission operable to increase the rotational speed of the rotary file relative to the rotational speed of the output shaft.

5. The portable dental system of claim 1 wherein:
the motor includes an output shaft that rotates, and
the hand-piece includes a transmission operable to rotate the rotary file at a rotational speed substantially equivalent to the rotational speed of the output shaft.

6. The portable dental system of claim 1 wherein the hand-piece includes a light system operable to project light toward the rotary file.

7. The portable dental system of claim 1 wherein the fluid delivery system includes a conduit disposed in the hand-piece and operable to dispense fluid toward the rotary file.

8. The portable dental system of claim 1 wherein the fluid delivery system includes a first fluid reservoir operable to store water and a second fluid reservoir operable to store air.

9. The portable dental system of claim 1 wherein:
the fluid delivery system includes a first fluid reservoir operable to store water and a second fluid reservoir operable to store air, and
the nozzle is operable to dispense water, air and a mist generated by combining water and air.

10. The portable dental system of claim 1 wherein the battery generates 27.6 volts when full.

11. The portable dental system of claim 1 wherein the battery is rechargeable.

12. The portable dental system of claim 1 wherein the dental system includes a first battery and a second battery, each generating 27.6 volts when full and each operable to power the motor of the drill system and the pump of the fluid delivery system.

13. The portable dental system of claim 1 wherein the control unit includes a user interface having switches for controlling the control unit and displays for presenting information generated by the control unit.

14. The portable dental system of claim 1 wherein the housing defines a cavity sized to retain the drill system, the fluid delivery system, the battery and the control unit, and that protects the drill system, the fluid delivery system, the battery and the control unit when each is disposed in the cavity.

15. The portable dental system of claim 14 wherein the housing includes:
a first section that the fluid delivery system, the battery and the control unit are mounted to, and
a second section including a hinge that connects the second section to the first section and allows the second section to pivot relative to the first section to open and close the housing, and a lock operable to prevent the second section from pivoting relative to the first section when the housing is closed.

16. A portable dental system comprising:
a drill system that includes
a rotary file operable to remove tissue from a patient,
a motor operable to rotate the rotary file, and
a hand-piece operable to couple the rotary file with the motor, and to provide a grip for holding the drill system while the motor rotates the rotary file;
a fluid delivery that is system operable to irrigate the rotary file and tissue when the rotary file is used to remove tissue from a patient, and that includes
a fluid reservoir to store fluid,
a nozzle operable to dispense fluid from the fluid reservoir, and
a pump operable to pressurize the fluid reservoir,
a control unit that is operable to control the drill system and the fluid delivery system, and that includes power circuitry operable to power the motor of the drill system and the pump of the fluid delivery system from a variety of different external power sources providing a variety of different voltages; and
a housing operable to protect the drill system, the fluid delivery system, the battery and the control unit.

17. The portable dental system of claim 16 wherein the external power sources include a battery that generates direct current and at least one of the following voltages: 12 volts and 24 volts.

18. The portable dental system of claim 16 wherein the external power sources include a source of alternating current at at least one of the following voltages: 110 volts and 220 volts.

19. The portable dental system of claim 16 wherein the power circuitry includes a booster circuit operable to increase the voltage to the motor of the drill system and to the pump of the fluid delivery system above the voltage provided by the external power source.

20. A portable dental system comprising:
a drill system that includes
a rotary file operable to remove tissue from a patient,
a motor operable to rotate the rotary file, and
a hand-piece operable to couple the rotary file with the motor, and to provide a grip for holding the drill system while the motor rotates the rotary file;
a fluid delivery system that is operable to irrigate the rotary file and tissue when the rotary file is used to remove tissue from a patient, and that includes
a fluid reservoir to store fluid,
a nozzle operable to dispense fluid from the fluid reservoir, and
a pump operable to pressurize the fluid reservoir,
a battery operable to power the motor of the drill system and the pump of the fluid delivery system;
a control unit that is operable to control the drill system and the fluid delivery system, and that includes power circuitry operable to power the motor of the drill system and the pump of the fluid delivery system from power provided by an external power source; and
a housing operable to protect the drill system, the fluid delivery system, the battery and the control unit.

21. The portable dental unit of claim 20 wherein the battery is rechargeable and the power circuitry is operable to recharge the battery from power provided by the external power source.

22. The portable dental unit of claim 20 further comprising:
a solar panel operable to generate power from light; and
wherein:
the battery is rechargeable, and
the solar panel is operable to recharge the battery.

23. A method for performing a dental/medical procedure, the method comprising powering at least one of the following systems, a fluid delivery system and a drill system, of a portable dental unit with a battery of the dental unit.

24. The method of claim 23 further comprising recharging the battery from at least one of the following external power sources, an external DC battery, an AC power source, and a solar panel.
